(19) United States
(12) Patent Application Publication
(10) Pub. No.: US 2020/0085074 A1
(43) Pub. Date: Mar. 19, 2020

(54) BEVERAGES, BEVERAGE CAPSULES AND PROCESSES OF PREPARATION OF BEVERAGES

(71) Applicant: NESTEC S.A, Vevey (CH)

(72) Inventors: Markus Kreuss, Freimettigen (CH); Virginie De Boishebert, Munsingen (CH); Nicole Rohrer, Reichenbach (CH)

(21) Appl. No.: 16/311,803

(22) PCT Filed: Jun. 27, 2017
(86) PCT No.: PCT/EP2017/065811

§ 371 Date: Dec. 20, 2018

(30) Foreign Application Priority Data
Jun. 28, 2016 (EP) 16176756.1

(51) Int. Cl. A23C 9/16; A23C 9/152

(52) U.S. Cl. CPC A23C 9/16; A23J 3/08; A23C 2260/20; A23C 9/1524

(57) ABSTRACT

The present invention relates to a beverage composition comprising a beverage mix component and a milk powder, wherein at least part of the milk powder comprises caseins and whey proteins wherein the milk powder has a mean diameter value Dv50 of at least 1 pm as measured by laser diffraction. The invention also relates to a process for producing and dispensing such a beverage composition. A capsule holding such a composition is also taught.

### FIELD OF THE INVENTION

The present invention relates to milk-based beverage composition prepared thereof as well as beverages prepared by vending systems comprising a milk product and a beverage mix component.

In particular, the invention is concerned with milk-based beverage composition comprising a protein complex which contributes to the improvement of creaminess, mouthfeel, foaming properties and texture, in particular of products based on lower and no fat formulations. A method of producing such beverage and the products obtainable from the method are also part of the present invention.

### BACKGROUND

Mouthfeel and creaminess as well as lower or reduced fat are key drivers of consumer liking for dairy based products such as coffee mixes or coffee enhancers as well as a high number of other products.

Today, there is a challenge to either increase or retain the mouthfeel/creaminess of powders when fat is reduced or removed. Thus the objective of the present invention is to use all-natural formulation or ideally by the product matrix itself, instead of adding ingredients to the product, particularly in low and no fat products.

It is known since 1980's that a slight pH adjustment of native fresh milk prior to heat treatment results in change of aggregation behavior between casein micelles and whey proteins. However, the pH range that was explored in milk never went down lower than pH 6.3 [F. Guyomarc'h. 2006. Formation of heat-induced protein aggregates in milk as a means to recover the whey protein fraction in cheese manufacture, and potential of heat-treating milk at alkaline pH values in order to keep its rennet coagulation properties. A review. Lait, 86, 1-20.]

It was surprisingly found that by mild acidification in the area of pH 5.7-6.3, the whey proteins in combination of controlled heat treatment (temperature and hold time) form complexes with the casein micelles, which results in increased colloidal particle size, water binding and overall viscosity. The problem also addressed by this invention is maintaining the structure and function after drying the composition. It was observed that current high pressure spray drying conditions for standard milk powder manufacture resulted in high shear effect that destroyed the controlled aggregation of proteins and thus the functionality during spray drying process.

It is object of present invention to provide an improved process to provide a milk-based beverage comprising milk powder that provides protection against loss of structure and function of aggregated proteins.

Adding thickeners (e.g. hydrocolloids, starches) has shown no big success due to unexpected texture change, flavor loss, increased length of ingredient list and also increased formulation costs.

EP0333288 relates to spray dried milk powder product and process for its preparation. It was found that a spray dried whole-milk powder with a coarser fat dispersion can be prepared by causing the spraying to be effected in such conditions that a considerable portion of the fat in the pre-concentrated milk product to be dried is in the solid state.

EP1127494 relates to a process for the preparation of fat-containing milk powder.

Thus it is object of the present invention to improve mouthfeel/texture/thickness/creaminess of the current products in the market. It is also an object of the present invention to keep mouthfeel/texture/thickness/creaminess of a product constant while reducing fat content. Furthermore it is also object of the present invention to keep mouthfeel/texture/thickness/creaminess of a product constant while reducing or eliminating thickening agents/stabilizers, e.g. hydrocolloids or starch.

Apart from mouthfeel/texture, foam is a key driver of consumer liking.

Also of particular importance would be to improve foam properties like texture, stability and volume.

For products, e.g. coffee enhancers or coffee creamers, to be mixed into acidic solutions, such as coffee, the stability in an acid environment is also very important as floccutlation and sedimentation in the final beverage is not desired.

Existing solutions to achieve a high foam ability is to increase protein content, which comes along with a cost increase. Existing solutions to increase foam stability is to add thickeners or stabilizers, which are not clean label. Thus it is object of the present invention to improve the foam texture as well as stability of the product in an acid environment.

### SUMMARY OF THE INVENTION

The present invention relates to a beverage comprising a beverage mix component and a milk powder, wherein milk powder comprises caseins and whey proteins such that, the milk powder upon reconstitution in an aqueous medium comprises casein-whey protein/fat aggregates and wherein the milk powder has a mean diameter value Dv50 of at least 1 μm as measured by laser diffraction. The beverage mix component comprises coffee, tea, fruit, herb, cocoa and combinations thereof.

One aspect of the present invention relates to a beverage composition comprising a beverage mix component and milk powder in the ratio of 1:2 to 1:12; wherein the characteristic of the milk powder is such that when milk powder is reconstituted at total solids of 10% (w/w) exhibits a shear viscosity of at least 1000 mPa·s measured at a shear stress of 10 Pa, a shear viscosity of at least 400 mPa·s measured at a shear rate of 100 l/s and a viscosity ratio between these two conditions of at least 1.3 as determined on flow curves obtained with a rheometer at 20° C.

In another aspect, the present invention relates to a process for preparing a beverage as defined above, comprising the steps of:
a) Providing a liquid milk concentrate at temperature below 25° C.;
b) Adjusting pH between 5.7 and 6.4;
c) Heat treating the composition at 80-150° C. for 3-300 seconds;
d) Cooling the composition below 70° C.;
e) Drying the composition after step d to get a milk powder,
f) Mixing soluble beverage mix component with the milk powder obtained in step e.

In yet another aspect, the present invention relates to a beverage capsule containing the beverage composition comprising a beverage mix component and milk powder in the ratio of 1:2 to 1:12; wherein the characteristic of the milk powder is such that when milk powder is reconstituted at total solids of 10% (w/w) exhibits a shear viscosity of at least 1000 mPa·s measured at a shear stress of 10 Pa, a shear viscosity of at least 400 mPa·s measured at a shear rate of 100 l/s and a viscosity ratio between these two conditions of at least 1.3 as determined on flow curves obtained with a rheometer at 20° C. The method further comprises the step of introducing an aqueous medium into the capsule to produce a beverage and dispensing the beverage from the capsule.

In yet another aspect, the present invention relates to a method for preparing a beverage comprising the step of mixing the beverage of the present invention defined above with an aqueous medium, preferably water. The step of mixing is implemented inside a beverage dispenser by means of a mechanical whipper or a water jet.

In yet another aspect, the present invention relates to a method for preparing a beverage inside a beverage dispenser, said beverage dispenser comprising at least one first container storing a soluble beverage mix component powder and at least one second container storing a soluble milk powder, said soluble milk powder as defined above in terms of its characteristics or obtained from the process steps a) to e) of the process defined above,
said method comprising the steps of:
   implementing step f) as defined above by dosing and mixing a dose of soluble beverage mix component powder from the first container and a dose of soluble milk powder from the second container to get a beverage of the present invention, and
   mixing the beverage mix composition with an aqueous medium, preferably water.

Another aspect of the present invention relates to a process for preparing a beverage composition comprising a beverage component and milk powder in the ratio of 1:2 to 1:12; wherein the milk powder is prepared by a process comprising the steps of:
a) Providing a liquid milk concentrate at temperature below 25° C.;
b) Adjusting pH to 5.7 and 6.4;
c) Heat treating the composition at 80-150° C. for 3-300 seconds;
d) Cooling the composition below 70° C.;
e) Drying the composition after step d.

In another aspect, the present invention relates to a beverage dispensing system comprising a plurality of dispensing units wherein
i) a single dispensing unit comprises the beverage composition comprising a beverage component and milk powder in the ratio of 1:2 to 1:12; wherein the characteristic of the milk powder is such that when milk powder is reconstituted at total solids of 10% (w/w) exhibits a shear viscosity of at least 1000 mPa·s measured at a shear stress of 10 Pa, a shear viscosity of at least 400 mPa·s measured at a shear rate of 100 l/s and a viscosity ratio between these two conditions of at least 1.3 as determined on flow curves obtained with a rheometer at 20° C.; or
ii) one unit comprises beverage component selected from the group comprising coffee, tea, fruit, herb, cocoa and combinations thereof and another unit comprises the milk powder separately wherein the characteristic of the milk powder is such that the milk powder upon reconstitution in an aqueous medium comprises casein-whey protein/fat aggregates and wherein the milk powder has a mean diameter value Dv50 of at least 1 μm as measured by laser diffraction.

### DESCRIPTION OF THE FIGURES

FIG. 1 shows the Particle Size distribution (PSD) of Prototype 1 as compared to a reference coffee mix beverage. PSD was measured in the final beverage.

FIG. 2 shows differential interference contrast (left) and phase contrast (right) light microscopy images of prototype 1 reconstituted in water. A: Reference product; B: Prototype 1 shows controlled aggregate formation which is a microscopy signature of protein complex formation at molecular scale. Scale bars are 20 microns.

FIG. 3 shows the particle size distribution (PSD) of prototype 2 as compared to a reference coffee mix beverage. PSD was measured in the final beverage.

FIG. 4 shows differential interference contrast (left) and phase contrast (right) light microscopy images of prototype 2 reconstituted in water. A: Reference product; B: Prototype 2 shows controlled aggregate formation which is a microscopy signature of protein complex formation at molecular scale. Scale bars are 20 microns.

FIG. 5 shows the particle size distribution (PSD) of prototype 3 as compared to a reference both for skimmed and full at milk. PSD was measured in the final beverage.

FIG. 6 shows differential interference contrast (left) and phase contrast (right) light microscopy images of prototype 3 (skimmed milk Latte Macchiato). A: Reference product; B: Prototype 3 shows controlled aggregate formation which is a microscopy signature of protein complex formation at molecular scale. Scale bars are 20 microns.

FIG. 7 shows the initial foam volume (10 s after frothing) in mL for skimmed milk (Ref 1 and Sample 1) and whole milk (Ref 2 and Sample 2), which demonstrates a significant improvement of initial foam volume.

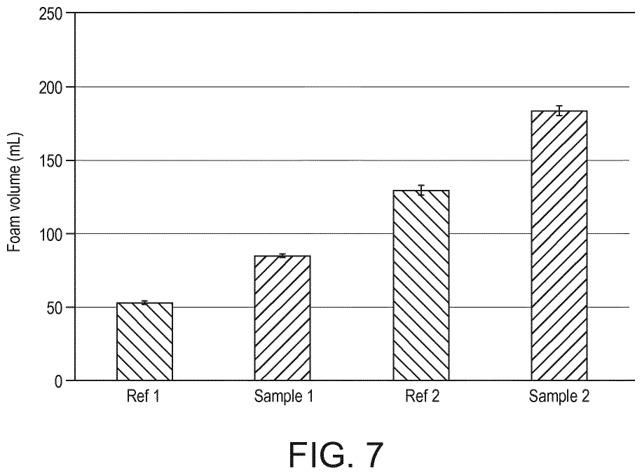

FIG. 8 shows particle size as a function of pH when acid is added to a solution of milk powder according to the invention and a reference sample, respectively (example 5).

### DETAILED DESCRIPTION

The term “beverage” refers to all types of milk based beverage in powder or liquid form, wherein at least part of milk is provided by the process of providing a liquid milk concentrate at temperature below 25° C.; Adjusting pH between 5.7 and 6.4; Heat treating the composition at 80-150° C. for 3-300 seconds; and Cooling the composition below 70° C. In one embodiment such cooled composition is further dried. The beverage may be a coffee mix and includes cappuccino types, café latte, with and without foams. The coffee mix in addition to coffee and milk can also contain other ingredients such as sugar, maltodextrin, flavours or texturizers.

The term “particles having mean diameter value Dv50” refers to protein network comprising casein micelles and whey proteins either present in aggregates. At pH below 6.5 the whey proteins show a strong tendency to form covalent aggregates with the casein micelles.

The mean diameter value Dv50 of the milk powder used in the beverage of the present invention ranges from 1 μm-30 μm. In one embodiment the Dv50 value ranges from 2 μm-25 μm. In another embodiment the Dv50 value ranges from 3 μm-20 μm. In yet another embodiment the d value ranges from 5 μm-10 μm.

In one embodiment of the present invention the drying is spray dried form using low pressure drying system. The mean diameter value Dv50 may range from 5-30 μm. The mean diameter value Dv50 may also range from 5-10 μm.

In one embodiment, the heat treatment of step c) mentioned above ranges from 80-100° C. for 30-300 seconds or at 130-150° C. for 3 to 15 seconds.

It has been shown during the experiments leading to this invention that the reconstituted spray dried milk powder when reconstituted at total solids between 10 to 50% (w/w) exhibits a shear viscosity of at least 1000 mPa·s measured at a shear stress of 10 Pa, a shear viscosity of at least 400 mPa·s measured at a shear rate of 100 l/s and a viscosity ratio between these two conditions of at least 1.3 as determined on flow curves obtained with a rheometer at 20° C. All compositions processed outside the conditions of the invention were not able to fulfill these 3 criteria simultaneously, indicating that the structure formed by the protein complex together with the fat droplets had a direct influence on the flow behavior of the system, and possibly on its textural properties.

In another embodiment, the present invention also relates to a process for preparing a milk powder comprising the steps of: a) Providing a liquid milk concentrate at temperature below 25° C.; b) Adjusting pH between 5.7 and 6.4; c) Heat treating the composition at 80-150° C. for 3-300 seconds such that the obtained composition retains exhibits a shear viscosity of at least at least 1000 mPa·s measured at a shear stress of 10 Pa, a shear viscosity of at least 400 mPa·s measured at a shear rate of 100 l/s and a viscosity ratio between these two conditions of at least 1.3 as determined on flow curves obtained with a rheometer at 20° C. at a concentration of at least 10% (w/w); d) Cooling the composition below 70° C.; and drying the composition after step d. In one embodiment of the present invention the drying is spray dried form using low pressure drying system. In one embodiment the step d) is performed below 60° C.

In a particular embodiment of the present invention, the dried milk powder is characterized by a low amount of air present in the powder granules after drying. More specifically the volume fraction of air in the powder granules is less than 2% as determined by image analysis performed on section of powder granules embedded in a historesin.

In a particular embodiment of the present invention, the drying is spray drying and the spray dried milk powder is characterized by a surprisingly low amount of air present in the powder granules after spray drying. More specifically the volume fraction of air in the powder granules is less than 2% as determined by image analysis.

The term “upon reconstitution in an aqueous medium” refers to reconstituting the milk powder into a liquid such as water. The liquid may be milk. Such a process is carried out typically at room temperature and may involve stirring means. The process may be carried out at elevated temperature, e.g. 85° C. for a hot beverage preparation.

It has surprisingly been found that texture and mouthfeel of dried milk powder is enhanced as a result of an optimized process of preparation including the controlled use of heat and acidic conditions.

These protein aggregates form a network that is suspected of binding water and entrapping fat globules (in case of presence of fat) and increases mix viscosity to create a uniquely smooth, creamy texture that mimics the presence of higher fat levels.

In one embodiment of the present invention, the spray-dried milk composition does not include any thickeners and/or stabilisers. Examples of such thickeners include hydrocolloids, e.g. xanthan gum, carrageenans, guar gum, locust bean gum or pectins as well as food grade starches or maltodextrins.

Several types of atomization are known for spray drying such as centrifugal wheel, hydraulic (high) pressure-nozzle, pneumatic (two phase nozzle) and sonic atomization. The term “low pressure drying system” refers to centrifugal wheel or pneumatic atomization systems which protects the structure of the casein-whey protein aggregates. It has been observed that high pressure atomizers such as hydraulic (high) pressure-nozzle atomization results in shearing effect thus destroying the casein-whey protein aggregates and thus its unique functionality. Such high pressure atomizers are useful for making conventional milk powders; however such a high-pressure system is not suitable for producing samples of the present invention.

In another embodiment, the coffee mix composition comprising coffee extract and milk powder in the ratio of 1:1 to 1:5; wherein the milk powder of the invention is dried with other methods of drying milk such as freeze drying and roller drying as alternative processes to achieve the intended product benefits. In particular the processes achieve a milk powder when reconstituted in aqueous medium results in casein-whey protein aggregate having a mean diameter value Dv50 ranging from 5-30 μm. The mean diameter value Dv50 may also range from 5-10 μm. In particular the processes achieve a milk powder upon reconstitution in an aqueous medium at a minimum of 10% (w/w) total solids exhibits a shear viscosity of at least 1000 mPa·s measured at a shear stress of 10 Pa, a shear viscosity of at least 400 mPa·s measured at a shear rate of 100 l/s and a viscosity ratio between these two conditions of at least 1.3 as determined on flow curves obtained with a rheometer at 20° C.

It should be noted that embodiments and features described in the context of one of the aspects of the present invention also apply to the other aspects of the invention.

The invention will now be described in further details in the following non-limiting examples.

### EXAMPLES

### Milk Powder 1 of the Present Invention (Skimmed Milk)

Fresh skimmed milk is preheated to 72° C. by a plate heat exchanger and concentrated by a Scheffers 3 effects falling film evaporator (from Scheffers B.V.) to approximately 45% total solids. The milk concentrate is cooled by a plate heat exchanger to 4° C. and pH adjusted to 6.0 using citric acid. The pH adjusted milk concentrate is preheated again to 60° C. by a plate heat exchanger and subsequently heated to 94° C. by direct steam injection system (self-construction of Nestle) with a holding time of around 150 seconds. After the heat treatment, the milk concentrate is rapidly cooled down by a 3VT460 CREPACO scrape heat exchanger (from APV Invensys Worb) to 50° C. The milk concentrate is then spray dried on a Nestlé 3.5 m Egron (self-construction) by a two-phase nozzle system (1.8 mm nozzle) to maximal moisture content of 3% and packed into air tight bags. Conditions of spray drying were: product flow of 342 L/h at 50° C. product temperature, hot air inlet temperature of 230° C. and an outlet air temperature of 72° C.

### Milk Powder 2 of Present Invention (Whole Milk)

Raw milk is preheated to 60° C. by a plate heat exchanger and homogenized by a Gaulin MC 15 10OTBSX high pressure homogenizer (250 bars). Subsequently, the homogenized milk is concentrated by a Scheffers 3 effects falling film evaporator (from Scheffers B.V.) to 35% (w/w) total solids. The milk concentrate is cooled by a plate heat exchanger to 4° C. and pH adjusted to 6.0 using citric acid. The pH adjusted milk concentrate is preheated again to 60° C. by a plate heat exchanger and subsequently heated to 87° C. by direct steam injection system (self-construction of Nestlé) with a holding time of 150 seconds. After the heat treatment, the milk concentrate is rapidly cooled down to 50° C. by a 3VT460 CREPACO scrape heat exchanger (from APV Invensys Worb). The milk concentrate is then spray dried on a Nestle 3.5 m Egron (self-construction) by a two-phase nozzle system (1.8 mm nozzle) to maximal moisture content of 3% and packed into air tight bags. Conditions of spray drying were: product flow of 380 kg/h at 48° C. product temperature, hot air inlet temperature of 250° C. and an outlet air temperature of 65° C.

Coffee mixes were prepared by mixing coffee freeze dried solids with milk powder (1 or 2) as described above. The recipe and nutrition of such a coffee mix is provided in below examples.

Four prototypes were prepared, Prototype 1=coffee mix with creamer; Prototype 2=Café Latte; Protoype 3=cappuccino and latte macchiatto prepared by a vending system and Prototype 4=aerated sweetened milk.

### Example 1: Prototype 1—Coffee Mix with Creamer

Coffee mix of present example is a dry mix of freeze dried coffee with non dairy creamer, sugar and ingredients such as maltodextrin, flavors and salt. Recipe and nutrition are given in table 1 and 2.

TABLE 1
Recipe of prototype 1

| Ingredient Name | Reference | Prototype 1 |
|---|---|---|
| Sugar | 13.993 | 12.500 |
| Non Dairy Creamer | 13.095 | 5.500 |
| Sample 1 of present invention | | 7.000 |
| Maltodextrin DE 19 | 3.173 | 3.173 |
| Freezed dried Coffee | 2.928 | 2.928 |
| Flavor Milk | 0.048 | 0.072 |
| NaCl | 0.040 | 0.040 |
| Flavor coffee | 0.019 | 0.025 |
| Total serving size | 34.050 | 31.992 |

TABLE 2
Nutritional data of prototype 1

| | | Nutrition | | |
|---|---|---|---|---|
| Component | | criteria/ | | |
| Name | Unit | serv* | Reference | Prototype 1 |
| Energy | KCal | 100 | 160.34 | 128.55 |
| Fat | g | 5.25 | 4.84 | 2.24 |
| SFA | g | 2 | 4.27 | 1.91 |
| Available | min required | 45-65% of tot | 72.15 | 57.85 |
| Carbohydrates | Cal from | Enengy | 110.64 | 101.27 |
| (total) | carb | | | |
| Lactose | | — | 0.25 | 3.70 |
| Sucrose, | g | 12.5 | 14.37 | 12.53 |
| Saccharose | | | | |
| Sodium | mg | 120 | 31.69 | 43.89 |

*Criteria defined by Nestle NHW (Nutrition Health and Wellness) based on public health recommendations and consumer sciences to evaluate the nutritional value of food and beverage

Sensory tests were carried out for above described samples and recorded in below table 3.

TABLE 3
Sensory evaluation of prototype 1

| | Reference | Prototype 1 |
|---|---|---|
| Odour | | More dairy |
| Flavour | slightly + sweet | More caramelic + |
| | | milky/+cream |
| Texture | | +mouthcoating + |
| | | thicknes |
| After Sensations | | Slightly + astringent |

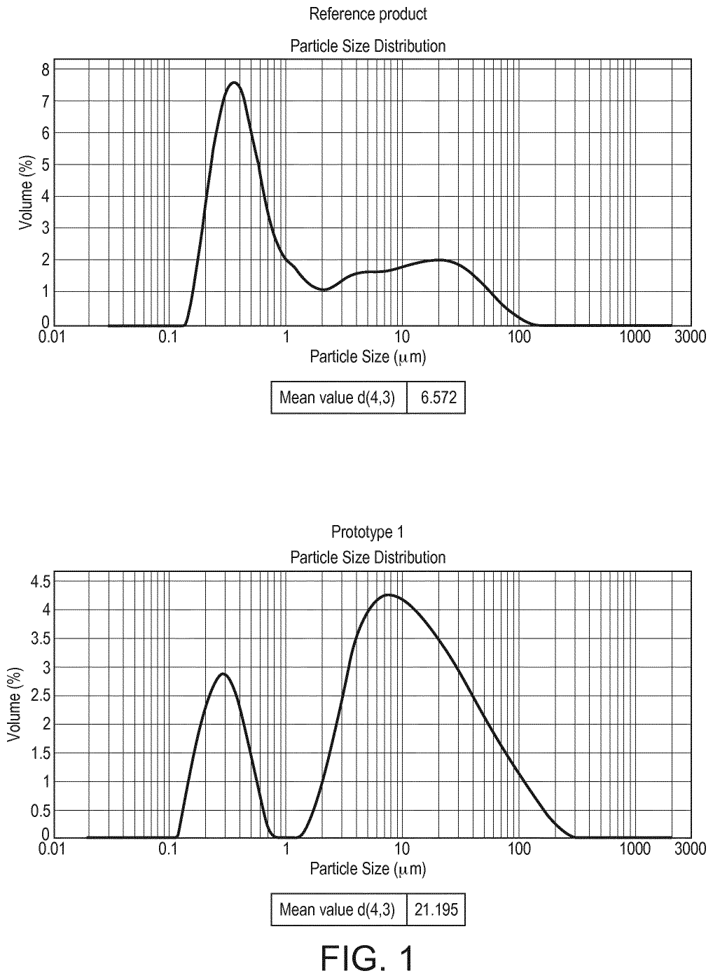

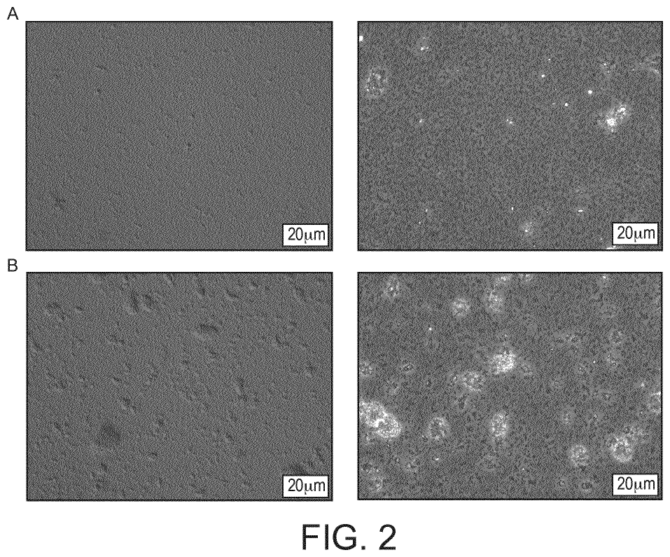

Analytical measurement of particles size distribution and microscopic observation were carried out and recorded in FIGS. 1 and 2.

### Example 2: Prototype 2—Café Latte

Prototype 2 is a coffee beverage containing foaming creamer and form layers after reconstitution. The recipe is showed in table 4.

TABLE 4
Recipe of prototype 2

| Ingredient Name | Reference (g) | Prototype 2 (g) |
|---|---|---|
| Foaming creamer | 4.50 | 4.50 |
| Filled daily creamer | 5.00 | 0.00 |
| Dietary Fibre | 7.86 | 7.86 |
| Sugar | 2.50 | 2.50 |
| NaCl | 0.08 | 0.08 |
| Carboxy Methyl Cellulose | 0.05 | 0.05 |
| Flavour Cream | 0.02 | 0.02 |
| Coffee freezed dried | 1.60 | 1.60 |
| Sample 1 of present invention | 0.00 | 5.00 |

Sensory tests were carried out for above described samples and recorded in below table 5. No significant colour difference was detected by lab analysis. The layering effect was more pronounced for prototype 2 versus reference.

TABLE 5
Sensory evaluation of prototype 2

| | Reference | Prototype 2 |
|---|---|---|
| Foam | | Ticker, sweeter, more milky, |
| | | more dense |
| Odour | | +dairy |
| Flavour | Slightly more | ++dairy/+cream |
| | sweet | cooked milk/++milky − |
| | | coffee |
| Texture | | +mouthcoating + |
| | | thicknes |
| After Sensations | | slightly astringent |

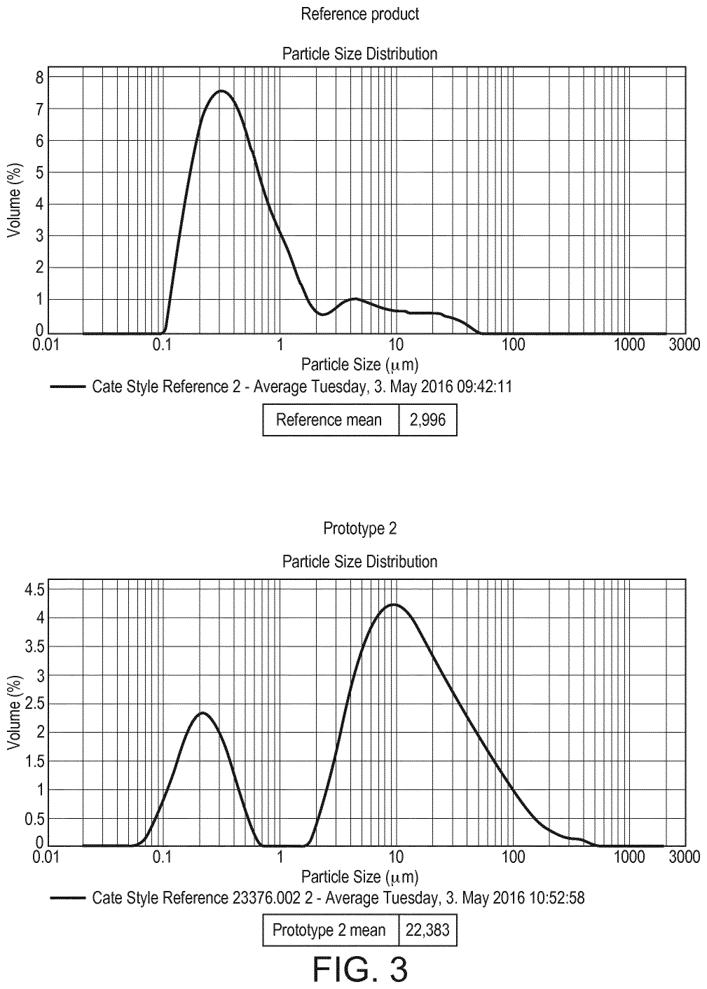

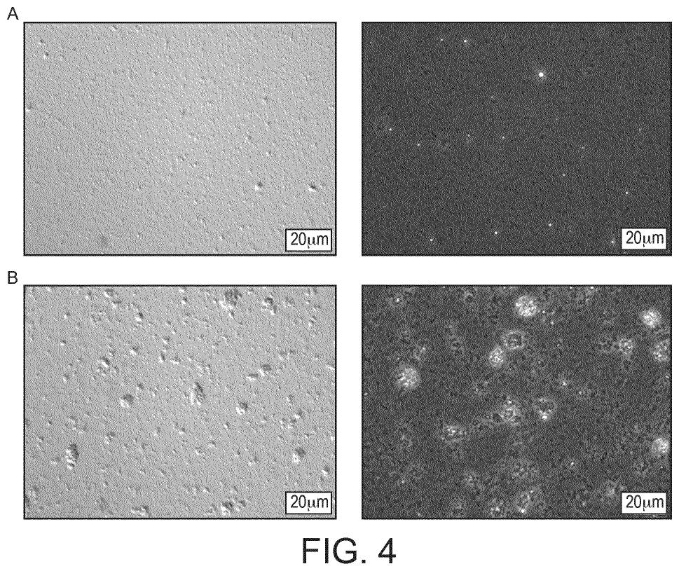

Analytical measurement of particles size distribution and microscopic observation were carried out and recorded in FIGS. 3 and 4.

### Example 3

Milk powder 1 and 2 of present invention were used in a coffee dispensing system (Nescafe Milano). The final beverage (Latte Macchiatto) had improved mouthfeel, foaming properties and foam texture. The recipe is described in below table 6.

TABLE 6
Prototype 3 - Latte Macchiatto from vending system

| | |
|---|---|
| Powder Ref, Sample 1, Sample 2 [g] | 18.4 |
| Water [mL] | 182.0 |
| Coffee [g] | 1.6 |

Sensory evaluation was carried out on beverage (milk with coffee Latte macchiato) dispensed from dispensing system as described above. The sensory data is shown in table 7 below. Microscopy of sample revealed an aggregated structure.

TABLE 7
Sensory evaluation of prototype 3
(Latte macchiato)

| Sample | Appearance | Odour | Flavour | Texture | After Sensations |
|---|---|---|---|---|---|
| Reference | | | | +watery | |
| Foam | | | | | |
| Reference | | coffee, milky | coffee, bitter | slightly more watery | |
| Beverage | | | Cappuccino | | |
| Foam of | | | | slightly thicker | |
| samples 1 and | | | | creamy foam, | |
| 2 of present | | | | very slightly longer on the tongue | |
| invention | | | | than reference | |
| | | | | less sweet | |
| Beverage of | darker | coffee, milky | creamy | +creamy, slightly + coffee | slightly astringent |
| samples 1 and | | | Cappuccino | | |
| 2 of present | | | | | |
| invention | | | | | |

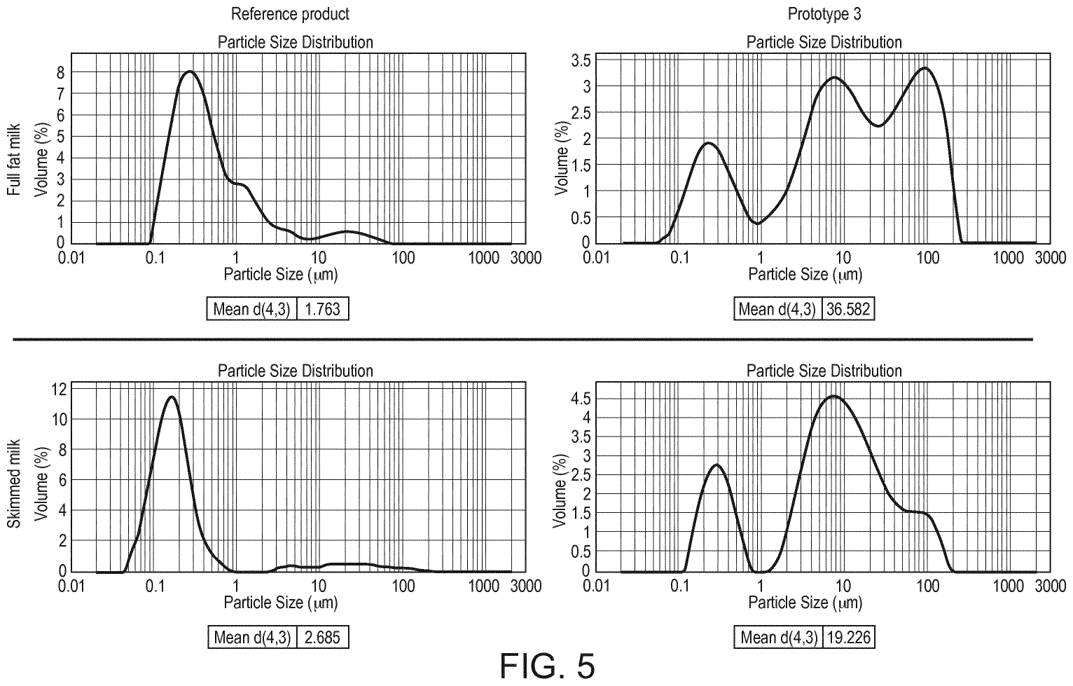

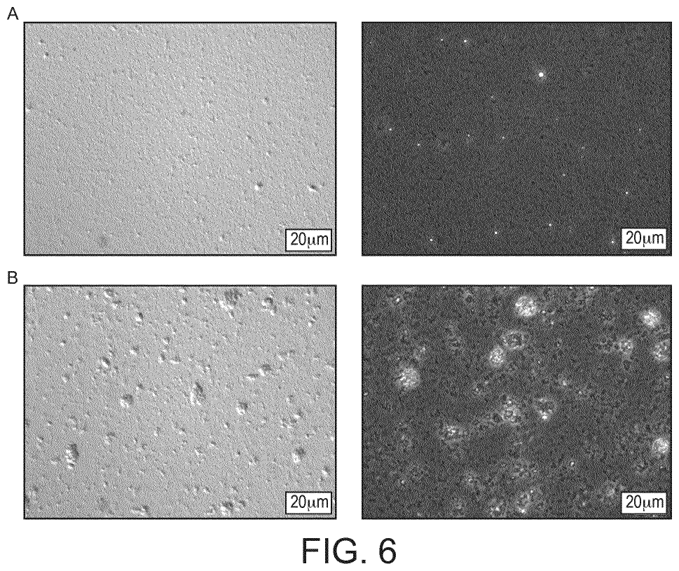

Analytical measurement of particles size distribution and microscopic observation were carried out and recorded in FIGS. 5 and 6.

### Example 4: Prototype 4—Frothed Sweetened Milk

Sample 1 or 2 of present invention were dissolved at 9 and 12.5% total solids and 5 g sugar was added. This sweetened milk beverage was frothed within a commercial milk froth device (Nespresso Aeroccino 3, Nestlé Nespresso SA, Switzerland) and compared to commercial skim and whole milk frothed by the same device.

The frothed milk beverages of present invention (both for skimmed and whole milk) had improved foaming properties and foam texture as compared to the reference samples.

Analytical measurement of particles size distribution and microscopic observation were carried out and recorded in FIGS. 5 and 6.

### Example 5: Improved Stability Against Protein Flocculation in Acidic Environment

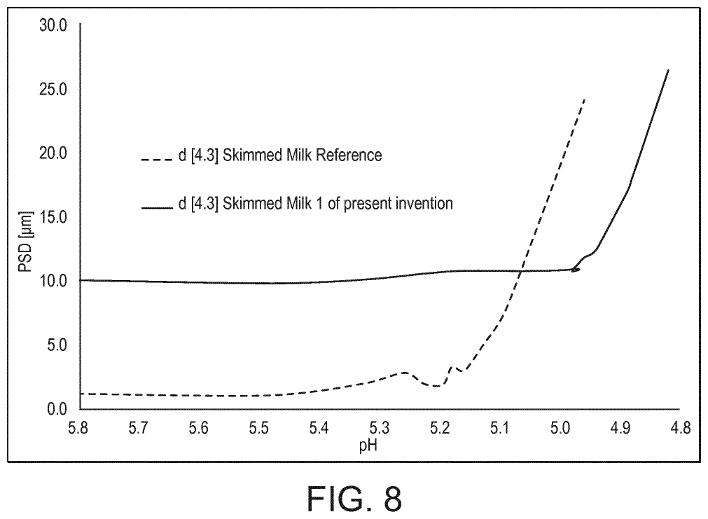

Milk powder 1 of present invention (skimmed milk) showed better stability against protein flocculation compared to a reference skimmed milk. For each sample, 25 g of powder were dissolved in 175 g of water at room temperature and stirred for 5 minutes. Phosphoric acid (at 5% concentration) was gradually added, and pH and particle size distribution (PSD) measured and recorded in FIG. 8.

PSD increase indicates flocculation of protein. Flocculates are detected from pH=5.2 for the reference milk, growing in size as pH decreases. For the milk made of milk powder 1 of the present invention), flocculates are being detected in a more acidic environment, from pH=5.0.

1. A beverage composition comprising a beverage mix component and a milk powder, wherein at least part of the milk powder comprises caseins and whey proteins such that, the milk powder upon reconstitution in an aqueous medium comprises casein-whey protein/fat aggregates and wherein the milk powder has a mean diameter value Dv50 of at least 1 μm as measured by laser diffraction.

2. The composition of claim 1, wherein the beverage mix component is selected from the group consisting of coffee, tea, fruit, herb, cocoa and combinations thereof.

3. The composition of claim 1 further comprises sugar, maltodextrin, flavors and texturizers.

4. The composition of claim 1, wherein the beverage mix component is coffee and wherein the beverage comprises coffee and milk powder in the ratio of 1:2 to 1:12.

5. The composition of claim 1, wherein the beverage mix component is cocoa and wherein the beverage comprises cocoa and milk powder in the ratio of 1:3 to 1:6.

6. The composition of claim 1, wherein the mean diameter value Dv50 of the reconstituted milk powder defined ranges from 1 μm-30 μm.

7. The composition of claim 1, wherein the mean diameter value Dv50 of the reconstituted milk powder defined ranges from 5-10 μm.

8. The composition of claim 1, wherein the milk powder is selected from the group consisting of a semi-skimmed, skimmed and whole milk powder.

9. A process for preparing a beverage composition comprising a beverage mix component and a milk powder, wherein at least part of the milk powder comprises caseins and whey proteins such that, the milk powder upon reconstitution in an aqueous medium comprises casein-whey protein/fat aggregates and wherein the milk powder has a mean diameter value Dv50 of at least 1 μm as measured by laser diffraction, comprising the steps of:
a) providing a liquid milk concentrate at temperature below 25° C.;
b) adjusting pH between 5.7 and 6.4;
c) heat treating the composition at 80-150° C. for 3-300 seconds;
d) cooling the composition below 70° C.;
e) drying the composition after step d to get a milk powder; and
f) mixing soluble beverage mix component with the milk powder obtained in step e.

10. A beverage capsule containing a beverage composition comprising a beverage mix component and a milk powder, wherein at least part of the milk powder comprises caseins and whey proteins such that, the milk powder upon reconstitution in an aqueous medium comprises casein-whey protein/fat aggregates and wherein the milk powder has a mean diameter value Dv50 of at least 1 μm as measured by laser diffraction.

11-14. (canceled)
